(19) United States
(12) Patent Application Publication
(10) Pub. No.: US 2014/0074502 A1
(43) Pub. Date: Mar. 13, 2014

(54) METHODS AND SYSTEMS FOR ANALYZING MEDICAL IMAGE DATA

(71) Applicant: Vidistar, LLC, Greenville, SC (US)

(72) Inventors: Craig Allan Walker, Greenville, SC (US); Michael Kostrzewa, Warsaw (PL); Steven Devann Johnson, Greenville, SC (US)

(73) Assignee: Vidistar, LLC, Greenville, SC (US)

(21) Appl. No.: 14/081,054

(22) Filed: Nov. 15, 2013

Related U.S. Application Data
(63) Continuation-in-part of application No. 13/507,195, filed on Jun. 11, 2012.
Application No. 13/507,195 is a continuation-in-part of application No. 12/932,973, filed on Mar. 10, 2011, now Pat. No. 8,200,505.
Application No. 12/932,973 is a continuation of application No. 11/592,608, filed on Nov. 3, 2006, now abandoned.
(60) Provisional application No. 61/727,364, filed on Nov. 16, 2012.

(51) Int. Cl. G06F 19/00

(52) U.S. Cl. CPC G06F 19/321; G06F 19/3443
USPC 705/2

(57) ABSTRACT

Methods and systems for analyzing medical image data can include use of a database having normal data thereon, each item of normal data having one or more first criteria associated therewith. Raw medical image data having one more second criteria associated therewith can be received. The normal data in the database can be filtered by comparing the first and second criteria to form a set of patient-specific normal data, while values can be extracted from the raw medical image data. The extracted information can be analyzed to determine patient-specific medical data that can be compared with the patient-specific normal data to generate an outcome. If the outcome indicates that the patient-specific medical data is normal, the patient-specific medical data can be added to the database of normal data.

### CROSS-REFERENCE TO RELATED APPLICATIONS

The present application claims priority to the co-pending United States Provisional Application for patent, having the Application Ser. No. 61/727,364, filed Nov. 16, 2012, which is incorporated by reference herein in its entirety. The present application also claims priority to the co-pending United States Application for patent, having the application Ser. No. 13/507,195, filed Oct. 11, 2012, which in turn claims priority to the United States Application for patent having the application Ser. No. 12/932,973, filed Mar. 10, 2011, now issued as U.S. Pat. No. 8,200,505, which in turn claims priority to the United States Application for patent, having the application Ser. No. 11/592,608, filed Nov. 3, 2008, each of which are incorporated by reference herein in their entirety.

### FIELD

Embodiments usable within the scope of the present disclosure relate, generally, to systems and methods for analyzing medical information, and more specifically, to systems and methods usable to process and analyze nuclear images and other types of medical image data, using and updating a database of normal data.

### BACKGROUND

Nuclear Medicine Imaging (NMI) is performed frequently in medical settings when it is necessary to view a patient's heart, e.g., to evaluate the functionality thereof. For example, a cardiac nuclear stress imaging test is performed by increasing a patient's heart rate (e.g., by instructing a patient to use a treadmill or pharmacological agent), injecting the patient with a radio isotope (e.g., a radionuclide combined with other compounds to form a radiopharmaceutical to promote attraction to a specific organ or other cellular material), then capturing and imaging the radioactive ions emitted from the radio isotope. A nuclear camera (e.g., a PET, SPECT, or gamma camera) is used to record the radiation emanating from the isotope. This procedure is then repeated when the patient's heart is at rest, and the two images are compared to determine the perfusion of the radioactive isotope in the patient's heart muscle. If heart muscle tissue is damaged, the isotope does not penetrate the tissue as readily, resulting in low perfusion, which can be detected through the imaging. Procedures such as this are necessary prior to performing numerous types of cardiac procedures, such as catheterization. As such, nuclear medicine primarily observes biological changes in a patient, rather than directly observing the patient's anatomy.

Nuclear images are robust collections of data, that are very large, and as such, the computerized computations and algorithms necessary to process such data are very complex. Nuclear imaging cameras obtain thousands of images, in multiple planes, that must be converted into slices, three-dimensional images/models, and animation. When performing cardiac imaging, this converted data must be used to determine the location of the outer, middle, and inner linings of the cardiac muscle, and this information must then be rendered in color, black and white, three dimensions, two dimensions, and in motion, where applicable. This plethora of processed data must then be analyzed, normally through comparison to a normalized data set, to determine the presence of any abnormalities.

Most currently-used products designed for this purpose are dated, and incapable of

Internet and/or http communication. Existing software for processing uses proprietary DICOM (Digital Imaging and Communications in Medicine) technology that does not comply with any universal standard format that can be interpreted using conventional software. As such, in many medical settings, a physician's access to this information and processing abilities is limited to a local workstation, located at the hospital where the nuclear camera and other equipment are located, specifically configured for the purpose of processing NMI images. For cardiologists that maintain a private office practice, time spent at a local workstation remote from their office often results in lower productivity and lower revenues.

Further, existing software primarily utilizes pre-established “normal databases,” e.g., data sets that consist of normal patient data, to which analyzed data from current patients can be compared to determine the extent of any abnormalities. A pre-established set of normal data does not properly account for expected variations in populations, e.g., due to region, age, weight, gender, etc., in combination with the pharmaceutical product and/or radio isotope used.

### SUMMARY

Embodiments usable within the scope of the present disclosure relate to methods and systems for analyzing data, and more specifically, to the analysis of medical image data including, without limitation, data related to NMI images. A database having “normal” data stored therein (e.g., data that does not indicate a medically significant outcome) can be provided, each data entry having one or more criteria associated therewith. For example, each data entry can correspond to an image or set of images received with regard to a patient, and various criteria associated therewith could include the patient's gender, age, location, weight, the radiopharmaceutical used to facilitate acquisition of the image, and/or other similar criteria that may have impacted the data during its acquisition.

Raw medical image data (e.g., DICOM data or data able to be converted to a DICOM format) can be received (e.g., data specific to a patient currently undergoing scans, treatments, and/or other medical procedures) for analysis. The raw medical image data can include one or more criteria associated therewith (e.g., a patient's gender, age, etc.). Data in the database can be filtered by comparing the criteria associated with the raw medical image that with those associated with each entry in the database to form a set of patient-specific normal data. For example, in some circumstances, it may be desirable to refine information in the database to form a set of normal data that accounts for the gender, age, location, etc., of a patient, to increase the accuracy of any comparisons by ensuring the relevance of the normal data used in such an analysis.

A plurality of slices (e.g., short axis slices in the case of NMI data) can be extracted from the raw medical image data, such as through use of a data mining module and/or one or more processing algorithms. For example, processing algorithms can be used to determine the coordinates of incoming NMI data most likely to correspond to a patient's myocardium and record the perfusion values at those coordinates. This information can be compared to the patient-specific normal data filtered from the database to generate an outcome (e.g., an indication of any significant deviation of the incoming data from the patient-specific normal data). For example, filtering of the database can include computing the mean and standard deviation of all values that correspond to the one or more criteria of the incoming data, while the outcome can include a determination whether the incoming data differs from the mean by greater or less than the standard deviation multiplied by a desired factor, or another threshold deviation.

If a determination is made that the analyzed data indicates a normal outcome, that data can be stored in the database as additional normal data. In various embodiments, one or multiple remote sources of data (e.g., medical offices) can transmit additional normal data to a centralized database, which can in turn push (e.g., synchronize) normal data with one or multiple systems in other locations, thereby enabling normal data from multiple locations to be stored and synchronized via a centralized server, such data being associated with relevant criteria (e.g., location, patient-specific information, pharmaceutical and/or other medical information, etc.), such that multiple systems and/or locations can query and utilize all or a portion of the database, as needed, e.g., for diagnostic and/or research purposes.

Systems usable within the scope of the present disclosure can include a receiving device (e.g., any manner of transmitter and/or receiver in communication with a network, such as the internet), adapted to receive data from one or more remote devices (e.g., image data from medical offices, hospitals, etc.). A data-mining module is usable to extract a plurality of datasets from received raw medical image data, each dataset having at least one criteria associated therewith. A processor is usable to apply one or more algorithms to the raw medical image data to obtain values associated therewith (e.g., by determining portions of the data that correspond to a myocardium or another medical feature). A database having normal data thereon, each item of data having one or more criteria associated therewith, can be filtered and applied to the analyzed data, in the manner described above.

### BRIEF DESCRIPTION OF THE DRAWINGS

In the detailed description of various embodiments usable within the scope of the present disclosure, presented below, reference is made to the accompanying drawings, in which:

FIG. 1 depicts a conceptual diagram of a database usable within the scope of the present disclosure.

FIG. 2 depicts a conceptual diagram of medical image data usable within the scope of the present disclosure.

FIG. 3 depicts an embodiment of a method for forming a normal database usable within the scope of the present disclosure.

FIG. 4 depicts a diagram of an embodiment of a system usable within the scope of the present disclosure.

FIG. 5 depicts a diagram of an embodiment of a system usable within the scope of the present disclosure.

One or more embodiments are described below with reference to the listed Figures.

### DETAILED DESCRIPTION OF THE EMBODIMENTS

Before describing selected embodiments of the present invention in detail, it is to be understood that the present invention is not limited to the particular embodiments described herein. 1The disclosure and description herein is illustrative and explanatory of one or more presently preferred embodiments of the invention and variations thereof, and it will be appreciated by those skilled in the art that various changes in the design, organization, order of operation, means of operation, equipment structures and location, methodology, and use of mechanical equivalents may be made without departing from the spirit of the invention.

As well, it should be understood the drawings are intended to illustrate and plainly disclose presently preferred embodiments of the invention to one of skill in the art, but are not intended to be manufacturing level drawings or renditions of final products and may include simplified conceptual views as desired for easier and quicker understanding or explanation of the invention. As well, the relative size and arrangement of the components may differ from that shown and still operate within the spirit of the invention as described throughout the present application.

Moreover, it will be understood that various directions such as “upper”, “lower”, “bottom”, “top”, “left”, “right”, and so forth are made only with respect to explanation in conjunction with the drawings, and that the components may be oriented differently, for instance, during transportation and manufacturing as well as operation. Because many varying and different embodiments may be made within the scope of the inventive concept(s) herein taught, and because many modifications may be made in the embodiments described herein, it is to be understood that the details herein are to be interpreted as illustrative and non-limiting.

Embodiments usable within the scope of the present disclosure relate to systems and methods usable to analyze data (e.g., medical image data). It should be noted that while specific embodiments described herein may focus on processes applied to data obtained using nuclear medical imaging (NMI) technology, focused on a patient's heart (e.g., the myocardium), embodiments described herein can be used in connection with other types of data without departing from the scope of the present disclosure. Additionally, while one purpose of various embodiments described herein may include the analysis of patient-specific data to determine the normalcy thereof and/or the presence of any medical abnormalities, data maintained and analyzed in the manner described herein can also be useful for research and/or study purposes, independent of any current and/or contemporaneous medical analysis relating to a specific patient. For example, users can readily query, filter, and customize data sets from within a centralized database for any desired purpose.

In various embodiments, a central server having a database of normal data can be placed in communication with multiple remote systems, e.g., via the internet, a local area network, or any other type of network. For example Transport Layer Security (TLS) DICOM Routers, or DICOM gateways, can be deployed at remote locations to enable transmission between those locations and a centralized PACS server (e.g., a server as described in U.S. Pat. No. 8,200,505 and application Ser. Nos. 11/592,608 and 12/932,973, incorporated by reference above), via TLS encryption. A remote location can configure its DICOM modalities to transmit data to the TLS DICOM router, which can in turn transmit data to the PACS server, which can be used to generate an output (e.g., a user interface for accessing a report) that is accessible from the remote location and/or other locations, e.g., via the internet (e.g., an http or https connection).

A database (e.g., a SQL or similarly-structured database) can be provided with a plurality of normal data, such as normalized perfusion values in all points of the myocardium, each value associated with one or more criteria. Such criteria can include any factors that may have an influence on the imaging process or other process used to obtain the data, and/or the outcome associated therewith. For example, in the case of patent gender, a NMI image obtained from a female patent would differ from that obtained from a male patient due to the radiation attenuation caused by breast tissue. In a similar manner patient location can affect data, e.g., due to dietary, environmental, and/or lifestyle conditions of the general population at a given location. Patient weight, age, race, etc. can also be used as criteria associated with data. Additionally, medical factors, such as the pharmaceutical used to facilitate obtaining medical images (e.g., Tc-99m, Thallium, etc.) can be stored in association with items of data, as can technological factors, such as gating corrections, the 3D reconstruction method and/or algorithm(s) used to process the data (e.g., filtered backprojecting method, various iterative algorithms), and the like.

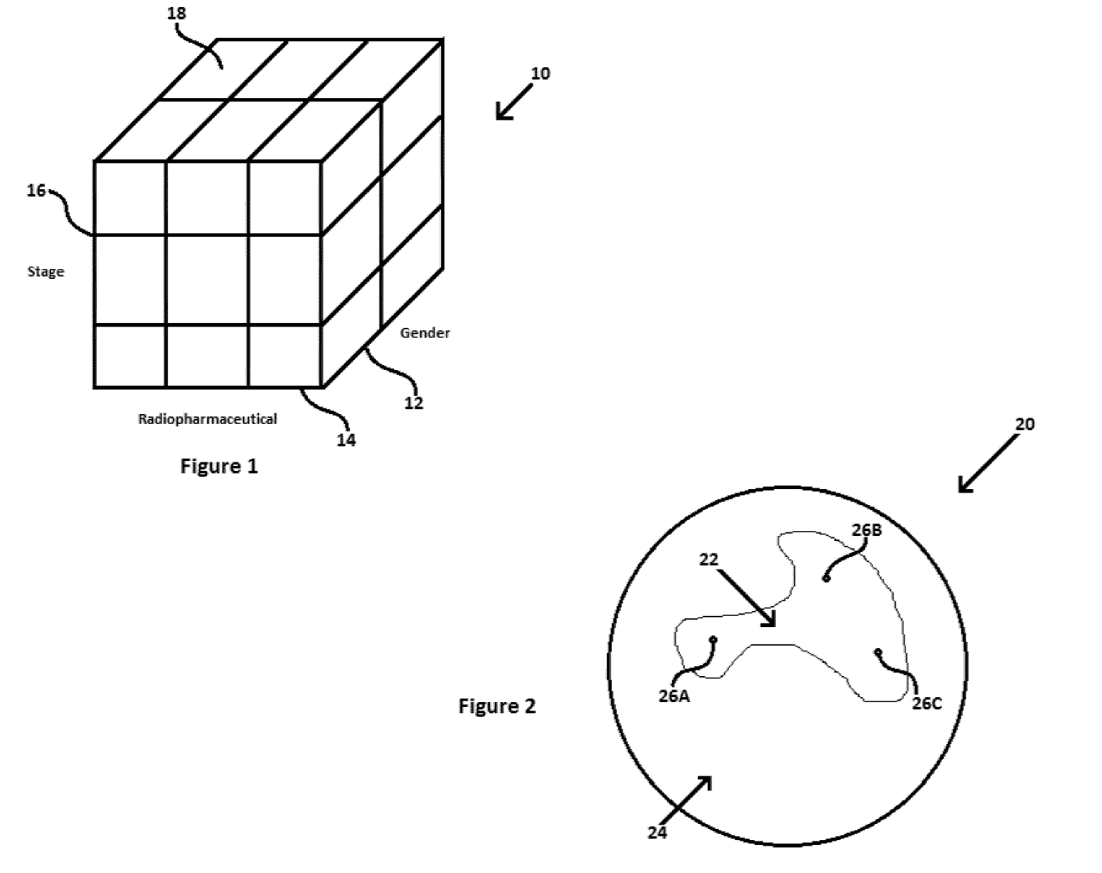

A database of normal data can be conceptualized as a multi-dimensional cube. For example, FIG. 1 depicts a conceptual diagram of a cube (10) representing a database usable within the scope of the present disclosure. Each cell of the cube (10), of which an exemplary cell (18) is labeled, can contain information regarding the average perfusion, and the standard deviation thereof, for each part of a heart for certain criteria/factors, each represented as a dimensional axis on the cube (10). For example, FIG. 1 depicts the cube (10) having an Y-axis (12) corresponding to a gender of a patient associated with a set of data, an X-axis (14) corresponding to the radiopharmaceutical used in conjunction with a set of data, and a Z-axis (16) corresponding to the stage of a procedure associated with a set of data. It should be understood that while FIG. 1 depicts a three-dimensional cube (10) having three axes (12, 14, 16) as a conceptual diagram, a multi-dimensional database can include any number of criteria, with each cell therein defined by the values associated with one or more of the criteria. For example, the exemplary cell (18) could correspond to a specific gender (e.g., female), a specific radiopharmaceutical (e.g., thallium), and a specific procedure stage. Each cell can thereby contain information regarding the statistical distribution of the perfusion in each point of the myocardium for certain coordinates (e.g., of a patient's scan and/or heart), associated with chosen criteria.

It should be understood that while FIG. 1 and the embodiments described herein focus on criteria that have typically have a statistically significant affect on NMI data and/or outcomes associated therewith, any criteria can be stored in association with data in the database, e.g., to facilitate future queries, studies, etc. In an embodiment, the statistical distribution of perfusion information in the database, which defines a “normal distribution” can only require the mean value and standard deviation at any given set of criteria to fully define a probability density function, by which incoming data (e.g., a current analysis associated with a patient) can be compared/analyzed.

For example, when NMI data relating to the perfusion value at certain points of a myocardium is received, these values can be described by providing coordinates (e.g., longitude and latitude) to each point. In an embodiment, algorithms can be used to extract this information at certain coordinates (corresponding to certain points of the myocardium), while values at other points can be determined by interpolation.

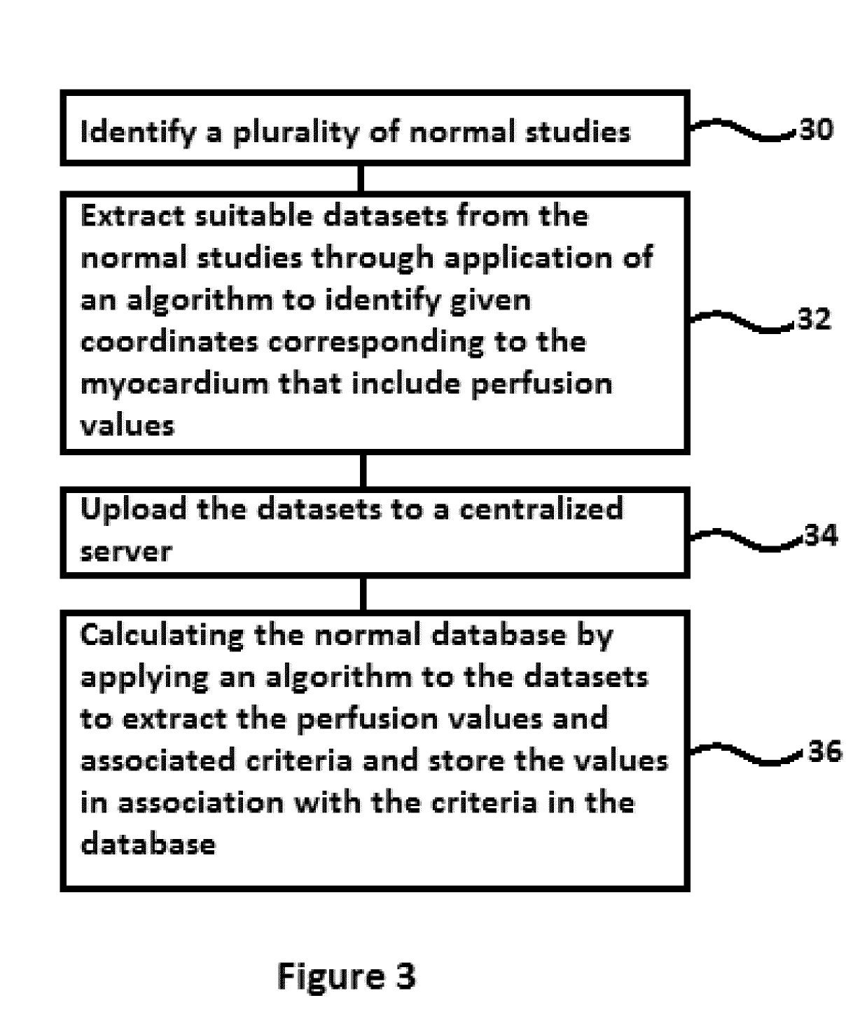

FIG. 2 depicts a conceptual diagram exhibiting medical data representative of a quantization (20) of perfusion information for a myocardium. The quantization (20) includes a first region (22) corresponding to the location of the heart, where perfusion is evaluated, and a second region (24) that may not necessarily be evaluated. Within the first region (22) three exemplary data points (26A, 26B, 26C) are labeled as exemplary points where the perfusion value can be evaluated, while values at other points could be determined by interpolation or other mathematical methods and/or algorithms. It should be understood, however, that in practice, perfusion information for a large number of data points (e.g., 700 or more) could be stored in the database. It should be understood that while FIG. 2 depicts a simplified conceptual diagram representing the quantization (20) of perfusion information for a myocardium, embodiments usable within the scope of the present disclosure can receive and utilize, for example, a polar plot on which every point of the myocardium is mapped to some point within the depicted circle.

To form the database of normal data, normal studies can be selected for inclusion therein using a variety of methods. In an embodiment, data can be selected automatically. For example, reports received in a DICOM structured report format and/or converted thereto, as described in U.S. Pat. No. 8,200,505 and application Ser. Nos. 11/592,608 and 12/932,973, incorporated by reference above, have a precisely defined structure, such that a logical rule can be built to determine whether a received study includes values that would classify the study as a normal study. Specifically, in various embodiments, a conversion engine can perform image recognition on received data (e.g., medical image data and/or other types of structured clinical reports) by identifying data therein, segmenting the report, using a library to perform value object extraction on the segments, and converting the value objects to a standard DICOM format. For example, when analyzing nuclear medicine data, a conversion engine can utilize a plug-in that analyzes nuclear datasets, builds a three-dimensional model of the heart, and extracts perfusion information to enable calculation of values useful for forming a diagnosis (e.g., ejection fraction, end diastolic volume, end systolic volume, summed stress score, etc.). Such values can be stored in a DICOM Structured Report, which, in an embodiment, can be automatically populated, e.g., for analysis by a physician, as described in U.S. Pat. No. 8,200,505.

A data-mining module can be used to extract such information from received studies, e.g., based on configurations provided by a user. In an embodiment, studies can be included in the database via automatic selection (e.g., meeting the criteria for “normal” detected by a computerized rule) and/or manual selection (e.g., studies specifically identified by a physician as normal). Combinations of these methods can be used as well. Various remote locations could compile location-specific databases using different methods. For example, a first location could choose to utilize the systems and methods described herein with a database of normal data that was generated locally, e.g., solely through studies performed at that location. A second location could utilize a database of normal data received from the centralized server, while refraining from adding and/or modifying information in the database. A third location could utilize the database of normal data from the centralized server, while also adding normal data obtained locally to the database. The centralized database can, in turn, be synchronized and/or otherwise receive additional data from one or more remote locations, e.g., as configured by users at remote locations and/or operators of the centralized database.

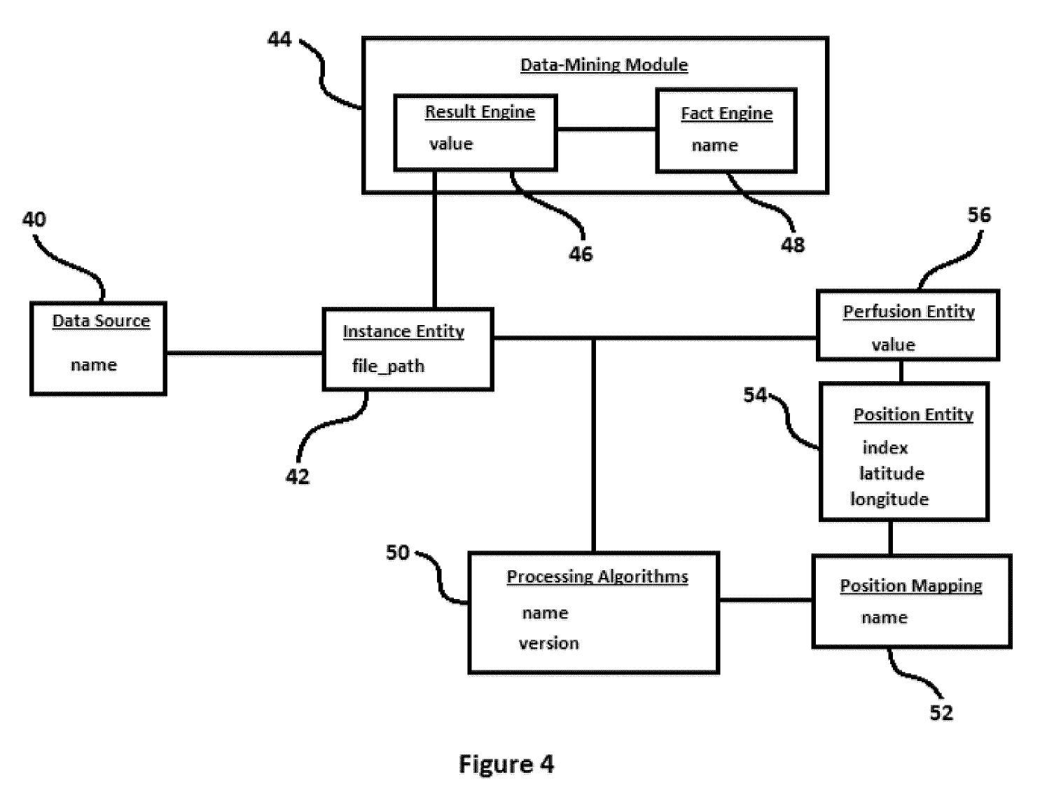

As such, embodiments usable within the scope of the present disclosure can form a normal database through a process of selecting suitable datasets, e.g., from a larger collection of data, such as a collection of studies deemed “normal” via an automated rule and/or manual denotation. FIG. 3 depicts an embodiment of a method for forming a normal database usable within the scope of the present disclosure. First, a plurality of normal studies can be identified (30), as described above (e.g., via automated rule or manual flagging/identification by a physician or other user). Such studies can be generated locally (e.g., at a remote location), or received from a centralized source of data.

One or more suitable datasets can then be extracted from the normal studies (32). To extract perfusion information from the studies, spatial, three-dimensional information on the perfusion at each point in the myocardium is needed. As such, this process can be performed through application of a processing algorithm that identifies the position of the myocardium and the corresponding coordinates thereof (e.g., three-dimensional coordinates) usable to evaluate the perfusion at each point in the muscle. This information can form, for example, a set of short axis slices that can be uploaded to a centralized server (34). For example, in an embodiment, datasets can be anonymized and transferred via HTTPS protocols or similar methods.

The normal database can then be calculated from the datasets (36). This process can be performed by applying one or more algorithms to the datasets to extract the perfusion values therefrom, along with any associated criteria (e.g., gender, stage, radiopharmaceutical, etc.). The perfusion values can then be stored in the database in association with a given set of criteria and given coordinates. In an embodiment, the normal database can refrain from forcing an end user to utilize a certain set of criteria due to the fact that the unaggregated data can be used, at any time, to compute a normal database for any set of criteria.

When a centralized database communicates with a remote location, encrypted HTTPS protocols can be used to transmit information via the internet. In an embodiment, a normal database engine can be used to perform this process, the engine including an online transactional processing module used to gather data from multiple remote locations and extract he perfusion information from those datasets; and an online analytical processing module used to generate statistical information from this data and thus, create a normal database when requested by a client.

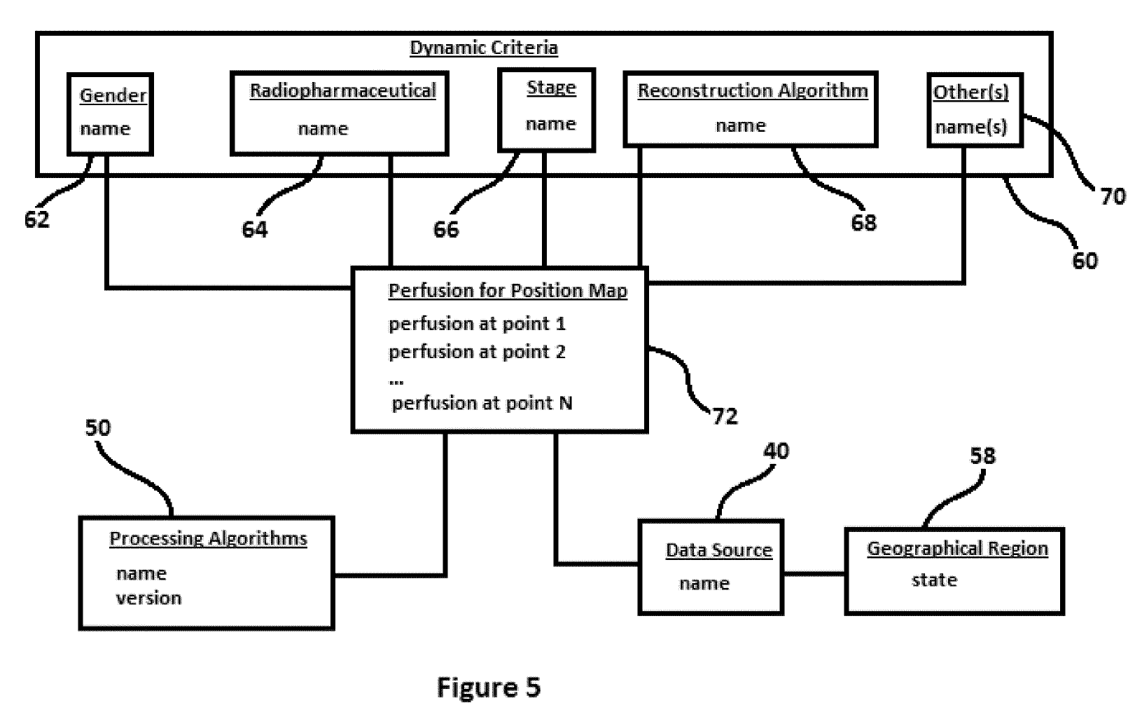

FIG. 4 depicts a diagram of a system (e.g., a database engine), usable within the scope of the present disclosure, to generate a normal database. A source of data (40), such as a physician's office/practice and/or any other location in communication with the system (e.g., via the internet or another type of network) can generate one or more datasets for transmission to a centralized server. The centralized server can identify and/or assign a geographic location to this incoming data and/or disable and/or otherwise discard data received from the source (40) if it is determined that incorrect datasets and/or other improper data has been transmitted. The instance entity (42) can represent a location, e.g., on a centralized server and/or otherwise in communication therewith, where the uploaded dataset(s) is/are stored, including a file path assigned to the dataset(s).

A data-mining module (44), such as that described in U.S. Pat. No. 8,200,505 and/or application Ser. Nos. 11/592,608 and 12/932,973, incorporated by reference above, can be used to extract values from the datasets. Specifically, a configurable set of values can be extracted that define a set of criteria usable by the system for subsequent operations. The data-mining module (44) is shown including a result engine (46) and a fact engine (48). The fact engine (48) can store information relating to the criteria to be extracted from incoming data (e.g., patient gender, radiopharmaceutical used, reconstruction method used, patient weight, stage of the study, etc.). The result engine (46) can store the values extracted for these criteria, for each dataset.

One or more processing algorithms (50) can be provided in communication with the instance entity (42), allowing the same instance, in an embodiment, to be processed by many algorithms or versions of algorithms, enabling a normal database to be generated based on the algorithm used. Each processing algorithm defines a position mapping (52) that determines, for example, how a myocardium is quantized (e.g., what points on a polar plot store extracted data). Each point on a plot for each mapping is stored in the position entity (54), while the perfusion value for each dataset, each algorithm, and each position is stored in the perfusion entity (56).

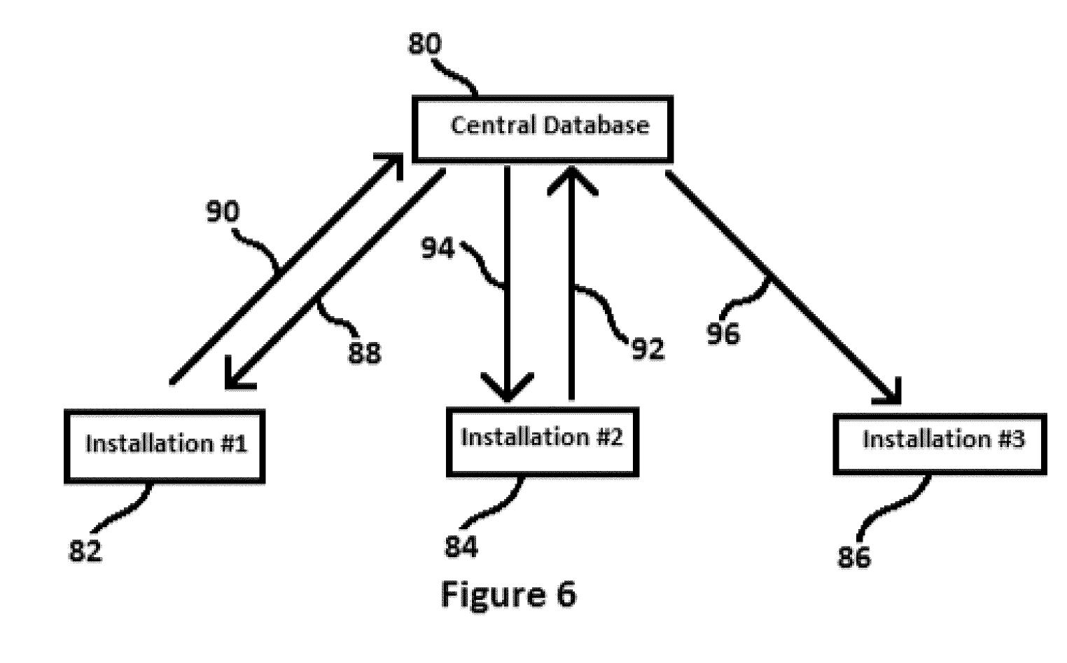

FIG. 5 depicts an embodiment of a system (e.g., an online analytical processing engine) usable within the scope of the present disclosure, e.g., to compute perfusion values at various points on a position map (e.g., coordinates on an image corresponding to a myocardium). Utilizing the depicted embodiment, a multi-dimensional cube representation, such as that shown in FIG. 2, can be created for each position map, and a fact table (72) containing the perfusion value at each point o the heart, defined on a dataset level, can be generated. A set of dynamic criteria (60) is depicted, which is depicted including exemplary criteria: gender (62), radiopharmaceutical (64), procedure stage (66), reconstruction algorithm used (68), and one or more other criteria (70). It should be understood that any number and type of criteria can be used to generate the fact table (72) without departing from the scope of the present disclosure.

The processing algorithms (50) used, the source of data (40), and the geographic region (58) associated with the source of data (40) can also be used to generate the fact table (72), as non-dynamic (e.g., hard-coded) criteria. By filtering the fact table using the dynamic criteria (60) and non-dynamic criteria (50, 40, 58), the normal database can be generated, which can contain the average and standard deviation of all points of a heart for any given set of criteria. Use of a system structured as depicted and described can enable such a normal database to be generated using a single database query (e.g., a SQL query). For example, each row in a fact table can include information for perfusion of the heart for a single dataset, processed by a particular algorithm and/or version thereof. By filtering the fact table using selected criteria (e.g., a given gender, procedure stage, reconstruction algorithm, etc), the resulting average results will include normal perfusion data usable, e.g., for comparison to a dataset. Filtering the fat table for all possible combinations of values in the criteria (e.g., all gender options, all stages, all reconstruction algorithms, etc.) can generate all possible average values for any given set of criteria, conceptually forming a multi-dimensional cube, as depicted in FIG. 1. As such, from a single fact table, multiple normal databases can be generated, depending on the set of criteria and corresponding values that are selected.

Through use of such a system, a normal database containing the perfusion values corresponding to any values for any of the dynamic criteria (60), and any combination of dynamic criteria can be obtained, simply through construction of a query, e.g., by a user, that includes the desired and/or meaningful criteria and values. Use of such a system to store data on a DICOM dataset level allows perfusion data to be calculated at a future time using new processing algorithms and/or new versions of existing algorithms. In an embodiment, the data can be generally non-normalized (e.g., undistorted through the generation and storage of interpolated values).

While use of such a normal database can be applied to diagnostic procedures (e.g., comparison of patient data with patient-specific normal data), the ability to arbitrarily extract criteria from the datasets can also allow the database to be used for reference purposes and scientific and/or research purposes (e.g., research relating to the usability of criteria not explored in existing software or literature).

Embodied systems usable within the scope of the present disclosure, such as those depicted in FIGS. 4 and 5, can be used to process any number of datasets to form a database. As such, embodiments usable within the scope of the present disclosure can include a centralized database (e.g., stored on or in communication with a networked server), in communication with a plurality of remote installations, from which additional normal datasets can be received, and to which an updated normal database can be transmitted.

FIG. 6 depicts a diagram of a system usable within the scope of the present disclosure, in which a centralized database (80) is in communication (e.g., via the internet or another type of network) with three remote installations (82, 84, 86) (e.g., medical facilities or other types of locations having, for example, a DICOM router and/or gateway installed). For example, in an embodiment, the installations (82, 84, 86) can communicate with the central database (80) over the internet, using HTTPS protocol, with all traffic therebetween being encrypted, and with all sides of each communication being authenticated through use of digital certificates and/or a Public Key Infrastructure (PKI). While FIG. 6 depicts three installations (82, 84, 86) in networked communication with a single centralized database (80), it should be understood that embodiments usable within the scope of the present disclosure can include any number of centralized severs and/or databases in communication with any number of remote installations.

Any of the installations (82, 84, 86) can be configured to transmit anonymized datasets (e.g., short axis slices of normal studies) to the centralized database (80), and in an embodiment, a lossless compression algorithm can be used to conserve bandwidth utilized by such transmissions. For example, the first installation (82) is shown transmitting datasets to the central database (80) via signal (90), and the second installation (84) is shown transmitting datasets to the central database via signal (92). In the depicted embodiment, the third installation (86) is shown illustrating a configuration in which the installation (86) is not adapted and/or configured to transmit datasets to the centralized database (80).

Any of the installations (82, 84, 86) can be configured to receive one or more normal databases from the central database (80), as illustrated by signal (88), signal (94), and signal (96), respectively. For example, an installation can request a normal database corresponding to a selected set of criteria (e.g., for female patients, living on the east coast, under stress, performed using a certain type of camera, in which the heart was reconstructed using a filtered backprojection algorithm). A normal database corresponding to selected criteria can be generated, e.g., contemporaneously, by the database engine, then transmitted to the installation in a DICOM Structured Report format. While FIG. 6 depicts each of the installations configured to receive normal databases from the centralized database (80), it should be understood that in various embodiments, installations may be configured to utilize a locally generated database that could, for example, be processed, analyzed, and/or otherwise manipulated using elements of the systems and/or methods described herein.

For example, an installation may be configured to use normal databases provided from the centralized database (80), without flagging local studies as normal, transmitting data to the centralized database (80), or constructing a local database. Alternatively, an installation may be configured to build a local database of normal data (e.g., pushed to a local server) for use with elements of the systems and methods described herein, without receiving normal databases from the centralized database (80). Such an installation could be configured to transmit local datasets to the centralized database (80) for use as additional normal data therein, or such an installation could be configured to refrain from such transmissions. Installations may be configured to both receive normal databases from the centralized database (80) and build a local normal database to be used in combination with the received normal database, with or without transmitting locally-obtained information to the centralized database (80).

Independent of the methods of data acquisition and maintenance undertaken by individual installations, data between a centralized server and one or more remote locations can be synchronized periodically or continuously, manually or automatically, to enable indexing and/or aggregation of data for generation of a normal database able to provide a higher confidence interval through continuously increasing sample sizes (e.g., reducing the standard deviation thereof).

It should be understood that while embodiments disclosed herein are described with emphasis on nuclear medical imaging technology and analysis of patient heart muscle, embodied systems and methods described herein could also be used with any other manner of DICOM data, including, without limitation, echocardiology ultrasound data, OBGYN data, nuclear data, CT data, X-ray data, general ultrasound data, vascular ultrasound data, Doppler data, and other similar types of information.

Embodiments usable within the scope of the present disclosure thereby enable remote processing of nuclear images and/or other types of medical images (e.g., via the internet) using standardized protocols and algorithms, polar mapping, LV volume curves, three-dimensional and two-dimensional images/processing, nuclear slices, static and dynamic imaging, and/or DICOM Structured Reporting technology (e.g., as described in U.S. Pat. No. 8,200,505, incorporated by reference above).

While various embodiments usable within the scope of the present disclosure have been described with emphasis, it should be understood that within the scope of the appended claims, the present invention can be practiced other than as specifically described herein.

What is claimed is:

1. A method for analyzing medical image data, the method comprising the steps of:
providing a database comprising a plurality of normal data, wherein each normal data comprises at least one first criterion associated therewith;
receiving raw medical image data comprising at least one second criterion associated therewith;
filtering the plurality of normal data by comparing said at least one second criterion with each of said at least one first criterion to form a set of patient-specific normal data;
extracting a plurality of slices from the raw medical image data;
analyzing the plurality of slices to determine patient-specific medical data; and
comparing the patient-specific medical data to the patient-specific normal data to generate an outcome.

2. The method of claim 1, wherein the outcome comprises a determination that the patient-specific medical data falls within a threshold deviation of the patient-specific normal data, the method further comprising the step of storing the patient-specific medical data in the database in association with said at least one second criterion, as additional normal data.

3. The method of claim 1, wherein the step of receiving the raw medical image data comprises receiving nuclear medical imaging data indicating perfusion information at a plurality of coordinates.

4. The method of claim 3, wherein the step of extracting the plurality of slices comprises extracting a plurality of short axis slices.

5. The method of claim 4, wherein the step of extracting the plurality of short axis slices comprises identifying a subset of coordinates corresponding to a myocardium and evaluating perfusion at the subset of the coordinates to form the plurality of short axis slices.

6. The method of claim 1, wherein the step of providing the database comprises structuring the database as a multi-dimensional cube having multiple axes, wherein each axis corresponds to one of said at least one first criterion, and wherein the step of filtering the plurality of normal data comprises retrieving cells of the multi-dimensional cube at locations along the axes corresponding to said at least one second criterion.

7. The method of claim 5, wherein the step of filtering the plurality of normal data comprises determining a mean and a standard deviation of data contained within all cells corresponding to said at least one second criterion.

8. The method of claim 6, wherein the step of filtering the plurality of normal data comprises performing a single database query.

9. A system for analyzing medical image data, the system comprising:
a receiving device in communication with at least one remote device for receiving raw medical image data therefrom;
a data mining module usable to extract a plurality of datasets from the raw medical image data, wherein the datasets comprise at least one first criterion;
a processor in communication with a data storage medium comprising at least one algorithm thereon, wherein the processor applies said at least one algorithm to the raw medical image data to obtain values associated with the raw medical image data; and
a database comprising a plurality of normal data, wherein each normal data comprises at least one second criterion associated therewith,
wherein the processor filters the plurality of normal data by comparing said at least one second criterion with each of said at least one first criterion to form a set of patient-specific normal data and compares the values to the patient-specific normal data to generate an outcome.

10. The system of claim 9, wherein the data mining module comprises a fact engine and a result engine, wherein the fact engine comprises a plurality of criteria to extract from the raw medical image data, and wherein the result engine is adapted to store extracted datasets and criteria.

11. The system of claim 9, wherein the raw medical image data comprises nuclear medical imaging data indicating perfusion information at a plurality of coordinates.

12. The system of claim 11, wherein said at least one algorithm comprises a processing algorithm defining a subset of coordinates corresponding to a myocardium, and wherein the processor evaluates perfusion values at the subset of coordinates to form the set of patient-specific normal data.

13. The system of claim 9, wherein the processor further receives an indication that at least one of the values comprises normal data and stores said at least one of the values in the database.

14. The system of claim 13, wherein the plurality of normal data comprises data received from a plurality of sources remote from the database.
